(19) United States
(12) Patent Application Publication
(10) Pub. No.: US 2013/0217799 A1
(43) Pub. Date: Aug. 22, 2013

(54) PROCESS FOR SYNTHESIZING POLYMERS WITH INTRINSIC MICROPOROSITY

(71) Applicants: Tymen Visser, Levis (CA); Yan Gao, St-Romuald (CA)

(72) Inventors: Tymen Visser, Levis (CA); Yan Gao, St-Romuald (CA)

(21) Appl. No.: 13/642,181

(22) PCT Filed: Apr. 20, 2010
(86) PCT No.: PCT/CA2010/000603

§ 371 Date: Mar. 27, 2013

(51) Int. Cl. C08G 73/00

(52) U.S. Cl. CPC C08G 73/00
USPC 521/180

(57) ABSTRACT

A process for synthesizing polymers with intrinsic microporosity comprises creating a solution of a first PIM-suitable monomer and a second PIM-suitable monomer in a solvent comprising N-methylpyrrolidone; and maintaining the solution at a temperature of at least 100° C. for a reaction time to yield the polymer with intrinsic microporosity.

For the United States of America, this application claims the benefit under 35 USC 119(e) of U.S. Application No. 61/170,710, filed on Apr. 20, 2009, which is incorporated herein in its entirety by this reference to it.

### FIELD

The specification relates to processes for synthesizing polymers with intrinsic microporosity. More particularly, the specification relates to processes for synthesizing polymers with intrinsic microporosity that are usable in membrane separation.

### INTRODUCTION

The following is not an admission that anything discussed below is prior art or part of the common general knowledge of persons skilled in the art.

United States Patent Application Publication No. 2006/0246273 A1 (McKeown et al.) discloses a microporous material which comprises organic macromolecules comprised of first generally planar species connected by rigid linkers having a point of contortion such that two adjacent first planar species connected by the linker are held in non-coplanar orientation, subject to the proviso that the first species are other than porphyrinic macrocycles. Materials in accordance with the invention have a surface area of at least 300 m²g⁻¹, eg in the range 700-1500 m²g⁻¹. Preferred points of contortion are spiro groups, bridged ring moieties and sterically congested single covalent bonds around which there is restricted rotation.

### SUMMARY

The following introduction is provided to introduce the reader to the more detailed discussion to follow. The introduction is not intended to limit or define the claims.

A process for synthesizing a polymer with intrinsic microporosity (PIMs) is disclosed herein. The process comprises creating a solution of a first PIM-suitable monomer and a second PIM-suitable monomer in a solvent comprising N-methylpyrrolidone; and maintaining the solution at an elevated temperature for a reaction time to yield a solution of the polymer with intrinsic microporosity. The reaction is homogenous, meaning that the polymer with intrinsic microporosity remains in solution during the reaction rather than precipitating out of solution during the reaction. The process produces a high molecular weight polymer, generally without cross-linking or branching, over a wide range of operating conditions. The process thereby helps facilitate the industrial use of PIM polymers, for example as a separation membrane material, by providing an improved, or at least alternate, process for synthesizing a PIM polymer.

More specific processes for synthesizing polymers with intrinsic microporosity are also disclosed herein. Some examples of processes comprise creating a solution of a bis(catechol) and a tetrafluoroterepthalonitrile or tetrachloroterepthalonitrile in a solvent comprising at least 30% N-methylpyrrolidone; and maintaining the solution at a temperature of at least 100° C. for a reaction time to yield a solution of a polymer with intrinsic microporosity.

Other examples of processes for synthesizing polymers with intrinsic microporosity comprise creating a solution of a first PIM-suitable monomer and a second PIM-suitable monomer in a solvent comprising N-methylpyrrolidone and another aprotic solvent; and maintaining the solution at an elevated temperature for a reaction time to yield a solution of a polymer with intrinsic microporosity.

### DETAILED DESCRIPTION

Various processes will be described below to provide an example of each claimed invention. No example described below limits any claimed invention and any claimed invention may cover processes that are not described below. The claimed inventions are not limited to processes having all of the features of any one process described below or to features common to multiple or all of the processes described below.

Polymers with intrinsic microporosity (PIMs) are polymers that form microporous solids. Without being limited by theory, it is believed that PIMs form these microporous solids because their highly rigid and contorted molecular structures cannot fill space efficiently.

In known methods for making PIMs, first and second PIM suitable monomers are combined and polymerized to yield a PIM. In one PIM-polymerization process described by McKeown et al. in US Patent Publication 2006/0246273 A1, the polymerization was carried out in solution in N,N-dimethylformamide (DMF) at temperatures between 60 and 70° C. Limited solubility of the progressing polymer chains in this solvent limited the concentration of the initial monomers in the solution (typically 2-8 wt %), and the reaction was still heterogenous, with PIMs typically precipitated during polymerization. Additionally, side reactions including cyclization and cross-linking took place readily, which resulted in broad molecular weight distributions and uncontrolled reactions. Further, a long reaction time (up to 72 hours) was required to obtain a molecular weight sufficient to give desired mechanical properties. After the reaction, gel particles and part of the cyclics have to be removed by a refining treatment before further usage of the polymerization product. In another process, described by Song et al. (Macromolecules 41 (20) 2008, p. 7411-7417), the reaction was carried out at higher monomer concentrations and under very high shear forces. In this process a mixture of N,N-dimethylacetamide (DMAc) and toluene was used as a solvent. The yield of this process was typically between 75 and 90%. The polymerization reaction was carried out at elevated temperatures with vigorous agitation. In this process, the polymers still precipitated during the reaction, but by vigorous agitation and adding more solvent during the reaction, the reaction time was reduced and higher molecular weight could be obtained while crosslinking and branching were suppressed relative to the McKeown et al. process. However, both of the processes described above have limited industrial applicability. The reaction has to be diluted significantly to minimize precipitation or needs very demanding equipment to have control of the product. A polymerization process wherein the polymer remains in solution is therefore highly desirable.

The polycondensation reactions described above used DMF and DMAc, which are aprotic polar solvents with high boiling point temperature. Other related solvents include, for example, N-methylpyrrolidone (NMP), dimethylsulphone (DMSO) and sulfolane. However since it had been shown in the previously mentioned examples that the PIM polymers, such as PIM-1, have limited solubility in two high boiling aprotic polar solvents, it would logically be expected that any similar solvent would produce a similarly disadvantageous reaction. Further, since the use of DMAc at elevated temperature still caused precipitation of the progressing polymer chain, and it is commonly considered in high temperature condensation polymerizations that toluene or other volatile solvents are necessary to azeotropically remove reaction-generated water to avoid branching or crosslinking, it would logically be expected that using a high temperature with an aprotic solvent for PIM polymerization would not be beneficial. Conversely, PIMS are soluble in other unrelated solvents such as chloroform, tetrahydrofuran and dichloromethane.

A process is disclosed herein for making polymers with intrinsic microporosity (PIMs). Despite the expectations described above, the process comprises creating a solution of a first PIM-suitable monomer and a second PIM-suitable monomer in a solvent comprising NMP at a material concentration (for example 30% or more); and maintaining the solution at an elevated temperature for a reaction time to yield a high molecular weight polymer with intrinsic microporosity, essentially without precipitation of the polymer thus formed. During the reaction the polymer stays in solution, even at high molecular weights, for example an Mp of 50,000 or more, suitable for polymers that can be used as membrane materials. Further, while toluene may be used in the solution, it is not necessary and a higher molecular weight polymer may be produced without it.

The inventors have found that PIMs are highly soluble in NMP or solvent mixtures of NMP at elevated temperatures, for example above 100° C. Further, it has been determined that the first and second PIM suitable monomers, as well as oligomers, are highly soluble in NMP at elevated temperatures, for example above 100° C. Extensive dilution of the reaction mixture with solvent is not necessary. The formed polymer may stay in NMP-solution up to about 35 wt % or more without the need to further dilute it during the reaction. This results in a more controlled reaction with high yield, which is easy to scale up. In addition, the reaction time is significantly shortened. For example, the reaction time may be between about 0.5 hour and about 2 hours, and the yield is essentially 100%, for example 98% or more. Further, cross-linking and branching is essentially suppressed. Accordingly, the reaction may be performed faster, with high control of molecular weight and polydispersity. Further, there is essentially no need for high shear agitation or any refining treatment of the product after the reaction.

The solvent may be essentially pure NMP. Alternately, the solvent may be a mixture of NMP with another aprotic solvent. For example, the solvent may comprise NMP and one or more of DMF, DMAc, and sulfolane. Alternately or in addition, the solvent may be a mixture of NMP with another compound, such as a volatile solvent such as toluene, xylene, or benzene. The latter compounds typically serve as dehydrating agents, but are not essential for the reaction to proceed and to obtain high molecular weights, and may even reduce the molecular weight of the PIM.

In some examples, the overall percentage of NMP in the solvent may be greater than 70%, and particularly, between 70% and 100%. However, in alternate examples, the overall percentage of NMP in the solvent may be less than 70%, for example as low as 30%. As will be described further hereinbelow, the overall percentage of NMP in the solvent, as well as the temperature of the solvent, may be selected based on the solubility of the PIM, and may depend on the nature of any other compounds in the solvent, and the nature of the PIM and PIM-suitable monomers.

The first PIM suitable monomer and the second PIM suitable monomer may be any compounds that are usable to form a PIM. More specifically, the first PIM suitable monomer and the second PIM suitable monomer may be any combination of monomers which a) combine to yield a very rigid polymer; and b) combine to yield a polymer within which there are sufficient structural features to induce a contorted structure that leads to microporosity. For example, United States Patent Application Publication No. 2006/0246273 (McKeown), which is incorporated herein by reference in its entirety, discloses PIMs wherein one of the first PIM suitable monomer and the second PIM suitable monomer is a planar species, and the other of the first PIM suitable monomer and the second PIM suitable monomer is a linker having a point of contortion. Six classes of PIM suitable monomers are disclosed. In the first class, the first PIM suitable monomer is a bis(catechol), and the second PIM suitable monomer is tetrafluoroterephthalontrile or tetrachloroterephthalontrile. The PIM formed by these PIM suitable monomers is referred to hereinafter as PIM-1. In the second class, the first PIM suitable monomer is of the formula Nu₂-R-Nu₂, and the second PIM suitable monomer is of the formula X₂—R′—X₂, where R and R′ are organic based moieties, and at least one of R and R′ contains a point of contortion. Nu represents a nucleophile, and X represents a good leaving group for nucleophilic substitution. In the third class, the first PIM suitable monomer is of the formula (H₂N)₂—R—(NH₂)₂, and the second PIM suitable monomer is of the formula (keto)₂-R′-(keto)₂ or (keto)(hydroxy)-R′-(keto)(hydroxy). At least one of R and R′ contains a point of contortion. In the fourth class, the first PIM suitable monomer is of the formula (H₂N)₂—R—(NH₂)₂, and the second PIM suitable monomer is a bis-anydride or bis-dicarboxylic monomer. At least one of (H₂N)₂—R—(NH₂)₂ and the a bis-anydride or bis-dicarboxylic monomer contains a point of contortion. In the fifth class, the first PIM suitable monomer is a halogenated bis-orthocarbonate, and the second PIM suitable monomer Nu₂-R-Nu₂. In this class, the halogenated bis-orthocarbonate contains a point of contortion, and the Nu₂-R-Nu₂ is a planar species. In the sixth class, the first PIM suitable monomer is Nu₂-R-Nu₂, and the second PIM suitable monomer is a compound containing a metal ion or phosphorus or silicon.

The solution of first and second PIM suitable monomers may be prepared at various concentrations. For example, the initial concentration of the first and second PIM suitable monomers in the solvent may be between about 0.03 g/mL and about 1 g/mL. More particularly, the initial concentration of the first and second PIM suitable monomers in the solvent may be between about 0.1 g/mL and about 0.53 g/mL. The PIM may remain in solution at a concentration of up to about 35 wt % or more, without the need to dilute it further during the reaction. While the PIM yield increases with concentration, viscosity of the solution also increases with the PIM concentration and the molecular weight of the resulting PIM may decline in a very high concentration reaction. A useful target concentration for the PIM is 18 to 24 wt %.

An inorganic base is added to the solution as a reactant, and may be a single or mixed alkali or alkaline-earth carbonate, bicarbonate, hydride, or hydroxide. A preferred base is potassium carbonate or bicarbonate. The initial ratio of the anhydrous potassium carbonate to monomer may be between 2 and 10. More particularly, the initial ratio of the anhydrous potassium carbonate to monomer may be between 2.1 and 4.

The solution is maintained at an elevated temperature for a reaction time in order to allow the first and second PIM suitable monomers to polymerize and yield the PIM. For example, the solution may be maintained above 100° C., and more specifically, at a temperature of between 100° C. and 210° C. Particularly, the solution may be maintained at between about 130° C. and 190° C. More particularly, the solution may be maintained at a temperature of between 155° C. and 160° C.

As mentioned hereinabove, the overall percentage of NMP in the solvent and the temperature of the solvent may be selected based on the solubility of the PIM. Preferably, the overall percentage of NMP in the solvent and the temperature of the solvent are selected such that the PIM is fully soluble in the solvent; however in some examples, the PIM may be only partially soluble in the solvent. For example, it has been determined that PIM-1 is partially soluble in a solvent comprising 70% NMP and 30% DMAc at a temperature of 110° C., and is fully soluble a solvent comprising 70% NMP and 30% DMAc at a temperature of between 155° C. and 160° C. Further, it has been determined that PIM-1 is partially soluble in a solvent comprising as low as 30% NMP and as high as 70% DMAc at a temperature of between 155° C. and 160° C. Accordingly, as the temperature of the solvent is increased, a solvent having a lower percentage of NMP may be selected, and as the percentage of NMP in the solvent is increased, a lower temperature of the solvent may be selected. Further, it is expected that if an even higher temperature is selected, the solubility of the PIM will increase, and an even lower percentage of NMP may be selected. For example, it is expected that PIM-1 will be increasingly soluble in a solvent comprising less than 70% NMP, for example as low as 30% NMP, at a temperature of greater than 160° C., for example up to 210° C. Further, it is expected that if a higher percentage of NMP in the solvent is selected, the solubility of the PIM will increase, and a lower temperature may be selected. For example, it is expected that PIM-1 will be at least partially soluble in pure or essentially pure NMP at temperatures as low as 100° C.

Further, the solubility of a PIM in a solvent having a given percentage of NMP and at a given temperature may depend on the nature of any other compounds in the solvent. For example, as noted hereinabove, it has been determined that PIM-1 is fully soluble a solvent comprising 70% NMP and 30% DMAc at a temperature of between 155° C. and 160° C. However, it has also been determined that PIM-1 is not soluble in a solvent comprising 70% NMP and 30% DMSO at a temperature of between 155° C. and 160° C.

Further, it is expected that the solubility of a PIM in a solvent having a given percentage of NMP and at a given temperature may depend on the nature of the PIM. For example, if different PIM suitable monomers are selected, and a different PIM is yielded, an alternate concentration of NMP in the solvent and an alternate temperature of the solvent may be selected. Further, in addition to selecting the overall percentage of NMP in the solvent and the temperature of the solvent such that the PIM is at least partially soluble in the solvent, the overall percentage of NMP in the solvent and the temperature of the solvent are further selected such that the first and second PIM-suitable monomers are at least partially soluble, and preferably fully soluble, in the solvent.

Optionally, the solvent may be pre-heated before forming the solution. Alternately, the solution may be heated after it is made.

The reaction time may be selected based on a desired molecular weight of the reaction. For example, the reaction time may be between about 2 min and 8 hours. More particularly, the reaction time may be between about 0.5 hour and about 2 hours. As shown in the Examples section hereinbelow, reaction times of between about 0.5 hours and about 2 hours give high molecular weight at yields of essentially 100%, for example 98% or more. However, if a reduced molecular weight is required, the reaction time may be less than 0.5 hour. Alternately, the reaction time may be more than 2 hours.

The reaction may be carried out in an inert atmosphere, for example under nitrogen or argon.

At the end of the reaction time, the reaction may be stopped, and the PIMs may be precipitated. For example, the reaction may be diluted with an additional amount of NMP, and then precipitated into water, methanol and/or higher alcohol. The resulting solid PIMs may optionally be washed and collected.

The PIMs may optionally be used in membrane separation, for example membrane separation of gases. For example, the PIMs may be formed into a film membrane.

### EXAMPLES

Example 1—Small Scale PIM-1 Synthesis: A 100 mL three-necked round bottom flask, which was equipped with an overhead mechanical stirrer, an gas inlet, and a Dean-Stark trap with condenser and gas outlet, was charged with 3.4044 g of 5,5′,6,6′-tetrahydroxy-3,3,3′,3′-tetramethylspirobisindane (TTSBI), 2.0054 g of tetrafluoroterephthalonitrile (TFTPN), 3.24 g of anhydrous potassium carbonate, 15 mL of NMP and 5 mL of toluene. Under nitrogen flow, the mixture was stirred at 155° C. under 340 rpm for 1 h. The reaction was then stopped and the reaction solution was diluted with 30 mL more NMP and precipitated into water. After several times of washing with acidic de-ionized water, the bright yellow fiber product was further washed with methanol once and collected by filtration. After drying, PIM-1 was yielded at about 99.6%. GPC analysis results are listed in Table 1.

TABLE 1
GPC Results

| | Mₚ | Mₙ | M_{w} | M_{w}/Mₙ |
|---|---|---|---|---|
| PIM-1 product | 63740 | 43355 | 62603 | 1.44 |

Eluent: NMP containing 0.2% LiBr and 0.03M of phosphoric acid, 1 ml/min; against polymethyl methacrylate standards

Example 2—Intermediate Scale PIM Synthesis: A 2 L four-necked flask, which was equipped with an overhead mechanical stirrer, an argon inlet, a thermal meter and a Dean-Stark trap with condenser and nitrogen outlet, was charged with 68.08 g of 5,5′,6,6′-tetrahydroxy-3,3,3′,3′-tetramethylspirobisindane (TTSBI), 40.10 g of tetrafluoroterephthalonitrile (TFTPN), 64.8 g of anhydrous potassium carbonate, 300 mL of NMP, and 100 mL of toluene. Under nitrogen flow, the mixture was stirred at 140° C. under 405 rpm for 2 h. The reaction was then stopped and the reaction solution was diluted with 600 mL more NMP and precipitated into water. After several times of washing with acidic de-ionized water, the bright yellow fiber product was further washed with methanol once and collected by filtration. The dried product was further purified with dissolving in CHCl₃ and precipitating in methanol. After drying, PIM-1 was yielded at about 98%. GPC analysis results are listed in Table 2.

TABLE 2
GPC Results

| Reaction time | Mₚ | Mₙ | M_{w} | M_{w}/Mₙ |
|---|---|---|---|---|
| 1 h | 72255 | 49826 | 69977 | 1.40 |
| 1.5 h | 74377 | 47068 | 70709 | 1.50 |
| 2 h | 73663 | 52092 | 71686 | 1.38 |

Eluent: NMP containing 0.2% LiBr and 0.03M of phosphoric acid, 1 mL/min; against polymethyl methacrylate standards

Example 3: Small scale PIM Synthesis wherein solvent is essentially NMP: A 100 mL three-necked round bottom flask, equipped with an overhead mechanical stirrer, a gas inlet and gas outlet, was charged with 3.4041 g of 5,5′,6,6′-tetrahydroxy-3,3,3′,3′-tertamethylspirobisindane (TTSBI), 1.9912 g of tetrafluoroterephthalonitrile (TFTPN), 3.24 g of anhydrous potassium carbonate and 20 ml of NMP. Under nitrogen flow, the mixture was stirred at 155° C. and 190 rpm for 1 hour. Subsequently, the reaction was stopped and the reaction solution was diluted with 30 ml NMP, followed by precipitation into de-ionized water. After several times of washing with de-ionized water, the obtained PIM-1 was dried and collected. Table 3, further below, shows the results of the GPC analysis of the resulting product. The GPC results in Table 3 are not directly comparable to the GPC results in Tables 1 and 2 because a different eluent system was used.

Example 4—Pre-industrial scale synthesis with NMP/toluene-solvent mixture: An 8 L Ross mixer, equipped with a gas inlet, Dean-stark trap with condenser and gas outlet, was charged with 2.24 L NMP, 0.84 L toluene, 595.73 g TTSBI, 567 g K₂CO₃ and 348.47 TFTPN g in sequence at a disperser speed of 1000 rpm and stirring speed of 30 rpm. After mixing at a disperser speed of 1500 rpm and stirring at 130 rpm for 30 minutes under continuous argon flow, the mixture was heated to 145° C. in 2 hours while toluene was refluxed and generated water was distilled off with the Dean-stark trap. Subsequently, the reaction was stopped by diluting with 3.2 L NMP and then precipitated into a 50/50 wt % methanol/water-mixture. After adequate washing with methanol/water and then deionized water, the dried product was yielded at essentially 100%. Table 3, further below, shows the results of the GPC analysis of the resulting product.

Example 5—Pre-industrial scale with pure NMP as solvent: An 8 L Ross mixer, equipped with a gas inlet, Dean-stark trap with condenser and gas outlet, was charged with 3.25 L NMP, 595.73 g TTSBI, 567 g K₂CO₃ and 348.47 g TFTPN in sequence at a disperser speed of 1000 rpm and stirring speed of 30 rpm. After mixing at a disperser speed of 1500 rpm and stirring at 130 rpm for 30 minutes under continuous argon flow, the mixture was heated to 135° C. in 1.25 hours. The reaction was stopped by diluting with 3.2 L NMP and then precipitated into water. After adequate washing with deionized water, the dried product was yielded at essentially 100%. Table 3 shows the results of the GPC analysis of the resulting product.

TABLE 3

| (M in g/mol) | Mp | Mn | Mw | Mw/Mn |
|---|---|---|---|---|
| Product example 3 | 140.000 | 21.500 | 148.000 | 6.9 |
| Product example 4 | 89.000 | 19.500 | 167.000 | 8.6 |
| Product example 5 | 157.000 | 29.000 | 215.000 | 7.4 |

Eluent: THF at a flow of 1 mL/min at 30° C. against polymethylmethacrylate (PMMA) standards

Example 6—Intrinsic Gas Permeation Properties: PIM-1 was prepared as described in example 5 and dissolved into chloroform at 5-10 wt %. Dense flat-sheet membranes (or films) were formed by casting the resulting polymer solution onto a flat glass plate using casting knifes. The solvent was slowly evaporated over night. The dry films were then peeled off the glass and further dried for at least 24 hours in vacuum at 120° C. The film thicknesses were measured with a micrometer screw gauge (average of 10 different measurements). Typically film thicknesses were obtained between 25 and 70 μm. Table 4 shows the average single gas permeation properties of more than 20 films measured at 50 psi and room temperature (21±1° C.) for N₂ and O₂.

TABLE 4
Intrinsic Gas Permeation Properties of two PIM-1 films

| | Permeability | Selectivity |
|---|---|---|
| Gas | (Barrer) | (Gas/N₂) |
| N₂ | 312 ± 60 | — |
| O₂ | 967 ± 166 | 3.1 ± 0.2 |

Example 7—Intrinsic Gas Permeation Properties: PIM-1 was prepared as described in example 2 and formed into dense films of 27 and 65 μm by solvent evaporation. Two 1 wt % solutions in chloroform were prepared and poured out into hydrophobic glass petri dishes and left over night to slowly evaporate the solvent. The dry films were peeled off the hydrophobic glass and further dried for 24 hours in vacuum at 70° C. The film thicknesses were measured with a micrometer screw gauge (average of 10 different measurements). Table 5 shows the single gas permeation properties measured at 50 psi and room temperature (21±1° C.) for N₂, CH₄, O₂ and CO₂.

TABLE 5
Intrinsic Gas Permeation Properties of two PIM-1 films

| | |
|---|---|
| PIM-1 film of 27 μm | PIM-1 film of 65 μm |

| | Permeability | Selectivity | Permeability | Selectivity |
|---|---|---|---|---|
| Gas | (Barrer) | (Gas/N₂) | (Barrer) | (Gas/N₂) |
| N₂ | 160 | 1.0 | 117 | 1.0 |
| CH₄ | 179 | 1.1 | 168 | 1.4 |
| O₂ | 515 | 3.2 | 365 | 3.1 |
| CO₂ | 2902 | 18.1 | 2180 | 18.6 |

Example 8—The solubility of PIM-1 in various solvents: The solubility of PIM-1 was tested in various solvents and at different temperatures. At room temperature, PIM-1 does not dissolve in NMP, DMAc, DMF, toluene and xylene. Two series of solvent mixtures were tested at higher temperatures. The first series included mixtures of NMP and DMAc. The second series included mixtures of NMP and DMSO. The amount of NMP in the mixtures ranged from 10 wt % to 100 wt %.

After 2.5 hours at 110° C., the PIM-1 in the 70/30 NMP/DMAc mixture showed signs of dissolving, including structure loss and coloration of the solvent (i.e. was partially dissolved), but was not fully dissolved. Increasing the temperature to 155° C. to 160° C. resulted in full dissolution of PIM-1 in the 70/30 NMP/DMAc mixture after 15 minutes.

After 1.5 hours at 155° C. to 160° C., the PIM-1 in the 50/50 NMP/DMAc and 30/70 NMP/DMAc mixtures showed signs of dissolution (i.e. was partially dissolved), but was not fully dissolved.

None of the DMSO mixtures showed signs of dissolution.

1. A process for synthesizing a polymer with intrinsic microporosity comprising:
a) creating a solution of a first PIM-suitable monomer and a second PIM-suitable monomer in a solvent comprising N-methylpyrrolidone; and
b) maintaining the solution at an elevated temperature for a reaction time to yield a solution of the polymer with intrinsic microporosity.

2. The process of claim 1, wherein step (a) further comprises dissolving an inorganic base in the solvent.

3. The process of claim 1, further comprising:
c) precipitating the polymer with intrinsic microporosity from the solution.

4. The process of claim 1, wherein the first PIM-suitable monomer comprises a bis(catechol), and the second PIM-suitable monomer comprises tetrafluoroterepthalonitrile or tetrachloroterephthalontrile.

5. The process of claim 1, wherein the solvent further comprises another aprotic solvent.

6. The process of claim 5, wherein the percentage of N-methylpyrrolidone and the other aprotic solvent in the solvent is selected such that the polymer with intrinsic microporosity is fully soluble in the solvent.

7. The process of claim 1, wherein the solvent comprises a mixture of N-methylpyrrolidone and dimethylacetamide.

8. The process of claim 1, wherein the solvent comprises at least 30 wt % N-methylpyrrolidone.

9. The process of claim 1, wherein the solvent comprises at least 50 wt % N-methylpyrrolidone.

10. The process of claim 1, wherein the solvent comprises at least 70 wt % N-methylpyrrolidone.

11. The process of claim 1, wherein the solvent comprises essentially pure N-methylpyrrolidone.

12. The process of claim 1, wherein the solvent further comprises toluene.

13. The process of claim 12, wherein the solvent comprises at least 75% N-methylpyrrolidone and at most 25% toluene.

14. The process of claim 1, wherein the solvent further comprises at least one of dimethylsulfoxide, sulfolane, and dimethylformamide.

15. The process of claim 2, wherein the inorganic base is anyhydrous potassium carbonate.

16. The process of claim 1, wherein the reaction time is between 0.8 min and 2 hours.

17. The process of claim 1, wherein the reaction time is 2 hours or less, and the yield of the reaction is greater than 98%.

18. The process of claim 1, wherein the temperature is selected such that the polymer with intrinsic microporosity is fully soluble in the solvent

19. The process of claim 1, wherein the temperature is above 100° C.

20. The process of claim 1, wherein the temperature is between 100° C. and 210° C.

21. The process of claim 1, wherein the temperature is between about 130° C. and 190° C.

22. The process of claim 1, wherein the temperature is between 155° C. and 160° C.

23. A process for making polymers with intrinsic microporosity comprising:
a) creating a solution of a bis(catechol) and a tetrafluoroterepthalonitrile or tetrachloroterepthalonitrile in a solvent comprising at least 30% N-methylpyrrolidone; and
b) maintaining the solution at a temperature of at least 100° C. for a reaction time to yield a solution of the polymer with intrinsic microporosity.

24-41. (canceled)

42. A process for synthesizing polymers with intrinsic microporosity comprising:
a) creating a solution of a first PIM-suitable monomer and a second PIM-suitable monomer in a solvent comprising N-methylpyrrolidone and another aprotic solvent; and
b) maintaining the solution at an elevated temperature for a reaction time to yield the polymer with intrinsic microporosity.

43-61. (canceled)

62. A process for synthesizing polymers with intrinsic microporosity comprising:
a) creating a solution of a first PIM-suitable monomer and a second PIM-suitable monomer in a solvent comprising at least one of N-methylpyrrolidone and dimethylsulfoxide; and
b) maintaining the solution at an elevated temperature for a reaction time to yield the polymer with intrinsic microporosity.

63. A process for synthesizing a polymer with intrinsic microporosity comprising:
a) creating a solution of a first PIM-suitable monomer and a second PIM-suitable monomer in a solvent comprising at least 30 wt % N-methylpyrrolidone;
b) maintaining the solution at a temperature of at least 100 C for a reaction time to yield a second solution of the polymer with intrinsic microporosity in the solvent, wherein the polymer with intrinsic permeability has a molecular weight of at least 50,000, is at least 18 wt % of the solution, and remains essentially in solution during the reaction time; and,
after step b), precipitating the polymer with intrinsic permeability.
